(19) United States
(12) Patent Application Publication
(10) Pub. No.: US 2025/0231854 A1
(43) Pub. Date: Jul. 17, 2025

(54) METHOD, APPARATUS, AND COMPUTER-READABLE MEDIUM FOR ADAPTING A PROCESSOR TO A WORKLOAD

(71) Applicant: Intel Corporation, Santa Clara, CA (US)

(72) Inventors: Marcin LISOWSKI, Gdynia (PL); Anna DREWEK-OSSOWICKA, Gdansk (PL); Kamil Tomasz ANDRZEJEWSKI, Maldyty (PL); Joshua B. FRYMAN, Corvallis, OR (US); Michal LEWANDOWSKI, Gdansk (PL)

(21) Appl. No.: 18/963,977

(22) Filed: Nov. 29, 2024

Related U.S. Application Data
(60) Provisional application No. 63/604,128, filed on Nov. 29, 2023.

(51) Int. Cl. G06F 11/34

(52) U.S. Cl. CPC G06F 11/3433; G06F 11/3452

(57) ABSTRACT

A method, apparatus, and non-transitory computer-readable medium for adapting a processor to a workload, wherein the workload comprises a steady phase and an unsteady phase. The method comprising detecting when the workload transitions to the steady phase from the unsteady phase, progressing through a plurality of actions of the processor from a default action of the plurality of actions, determining a performance of the processor for each of the plurality of actions, selecting an optimized action of the plurality of actions based on the corresponding performance of the processor, and returning to the default action when the workload transitions to the unsteady phase from the steady phase.

### BACKGROUND

Central processing units (CPUs) and other processors for server and client systems consist of a tremendous number of hardware knobs, enabling and disabling specific hardware features or functionalities. Often these CPUs are delivered to the customers with some set of default settings for CPU knobs. However, this default set is not optimal for all existing workloads, in terms of their performance or power/performance ratio. Therefore, there is a demand to improve CPU performance by finding and applying optimal sets of CPU settings for particular workloads.

### BRIEF DESCRIPTION OF THE FIGURES

Some examples of apparatuses and/or methods will be described in the following by way of example only, and with reference to the accompanying figures, in which

FIG. 1 shows a flowchart of a method for adapting a processor to a workload;

FIG. 2 shows a general schema of an agent control loop with a Thompson-Sampling Gaussian Bandit;

FIG. 3 shows an example of a Thompson-Sampling Gaussian Bandit algorithm description;

FIG. 4 shows an example of an algorithm for a steady-phase detector;

FIG. 5 shows an example of an algorithm for a Gaussian bandit tuner;

FIG. 6 shows an illustration of a Thompson-Sampling Gaussian Bandit working over time;

FIG. 7 shows an illustration of a probability distribution update of a particular action over time; and

FIG. 8 shows an illustration of a computing device for adapting a processor to a workload.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification. Optional components may be illustrated using broken, dashed, or dotted lines.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

When two elements A and B are combined using an “or,” this is to be understood as disclosing all possible combinations (i.e. only A, only B, as well as A and B) unless expressly defined otherwise in the individual case. As an alternative wording for the same combinations, “at least one of A and B” or “A and/or B” may be used. This applies equivalently to combinations of more than two elements.

If a singular form, such as “a” “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include” “including” “comprise” and/or “comprising” when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Unless otherwise defined, all terms (including technical and scientific terms) are used herein in their ordinary meaning of the art to which the examples belong.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating” “executing” or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

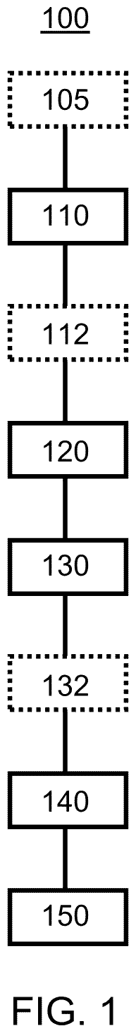

FIG. 1 shows a flowchart of a method 100 for adapting a processor to a workload, wherein the workload includes a steady phase and an unsteady phase. The method 100 may include detecting 110 when the workload transitions to the steady phase from the unsteady phase, progressing 120 through a plurality of actions of the processor from a default action of the plurality of actions, determining a performance of the processor 130 for each of the plurality of actions, selecting 140 an optimized action of the plurality of actions based on the corresponding performance of the processor, and returning 150 to the default action when the workload transitions to the unsteady phase from the steady phase. The embodiments disclosed herein may dynamically optimize processor performance by detecting workload phases and adjusting CPU settings using a lightweight, deployable agent. This ensures improved power-to-performance ratios for workloads on legacy and modern processors.

Workloads of a central processing unit (CPU) or other processor may consist of phases. A phase may be a time interval observed during a workload run for which a specific set of hardware (HW) knobs is optimal in terms of workload performance or power/performance ratio. Phases, as well as sets of optimal settings for HW knobs, can be discovered (phases) or regulated (HW knobs/settings) automatically by an autonomous agent in a runtime manner. Hardware knobs are knobs exposed through the Model Specific Registers (MSR) interface. Examples of such knobs are specific bits in MSRs enabling/disabling L1/L2 prefetching, a turbo setting, or dynamic frequency scaling technologies. MSRs are special-purpose registers in a computer processor that provide a low-level configuration, control, and monitoring mechanism, allowing the processor to expose and manage hardware-specific features and settings. L1 and L2 refer to levels in the processor's memory hierarchy, which are small, high-speed memory units located closer to the processor cores than main memory (e.g. RAM). Level 1 (L1) or primary cache is the faster and smaller, often split into separate instruction and data caches, while and Level 2 (L2) or secondary cache is larger and slightly slower but shared across cores in many architectures. Prefetching these caches involves predicting what data the processor will need next and loading it into the cache ahead of time to reduce memory latency and improve performance.

An example of a workload may be a game or movie. These workloads may be more intensive than others, such as displaying a web page, and benefit from processor settings that are not easily exposed to the users. Computer hardware has loads of settings that users are unaware of or use. However, these settings may strongly influence how programs work and how efficient and speedy these programs are. By dynamically adapting processor settings at runtime to better fit the workload, performance may be better than simply using default settings that are tuned for a general set of workloads.

Actions may be a set of settings applied to the CPU to optimize workload performance. These settings can be represented as a bitmask, where each bit corresponds to the state of a specific hardware feature. For example, actions encoded in a bitmask may include enabling or disabling prefetchers, adjusting dynamic frequency scaling parameters, or modifying other processor settings exposed through MSRs. Progressing 120 or cycling through a plurality of actions may occur in various ways, such as iterating in order, selecting at random, or following a programmed strategy. In one embodiment, the method 100 may first select an action at random and then use probabilistic distributions of instructions per second (IPS) to guide subsequent action selection. IPS refers to the number of instructions executed by a processor per second and serves as a key metric of processor performance. IPS is calculated by dividing the total number of instructions executed during a time measurement by the duration of that measurement, typically standardized to one second. The number of executed instructions is accumulated over the specified period using performance counters, and IPS may represent an average rate if the time measurement spans multiple intervals. A time measurement may be obtained using a hardware timer or clock source, which generates signals or counts indicative of elapsed time. Such measurements can be derived from processor-specific performance counters or system-level timekeeping components configured to record intervals between events. Additionally, instructions per cycle (IPC) may be used as an alternative or complementary performance metric. IPC refers to the average number of instructions executed per clock cycle and is calculated by dividing the total number of executed instructions by the number of clock cycles elapsed during a workload phase. IPC may provide insights into processor efficiency, independent of clock frequency or time duration.

An agent performing the method 100 may be potentially placed at the hardware level, for example in one of the microcontrollers, like a power control unit (PCU), implemented in firmware. The agent may treat hardware knobs as black boxes, aside from what specific hardware functionality is enabled/disabled by a particular knob, as long as a specific HW knob has an impact on workload performance and/or a power-to-performance ratio. As input for the decision-making process, the agent takes HW telemetry counters (e.g. branch instructions, instructions, cycles, branch misses, etc.), which are used for discovering phase and assessing current workload performance.

Conventional techniques for optimizing processor performance rely heavily on static configurations or user-defined profiles, which are predetermined and often fail to account for the dynamic nature of modern workloads. These approaches typically involve setting hardware knobs (e.g. prefetching, frequency scaling) at design or boot time based on general assumptions about average use cases. While such techniques ensure broad compatibility, they lack the adaptability to optimize for specific workload phases or variations in real time. Some recent techniques involve expert users or developers manually tuning HW knobs. However, these are labor-intensive, prone to error, and impractical for environments with diverse or rapidly changing workloads, such as data centers or edge computing systems. Additionally, existing systems rarely leverage telemetry data dynamically, missing opportunities to fine-tune processor settings for performance gains or power efficiency during runtime. Employing an autonomous agent to find and apply optimal CPU settings may result in efficient, workload-specific adaptation without requiring extensive user intervention.

Generally, the agent for the method may be a logical construct, which, when implemented for instance in firmware (FW), may improve CPU performance “for free”, by discovering workload phases as well as finding an optimal set of CPU settings for particular phase and configuring the processor with the optimal set of settings. However, determining which settings apply to which workload presents a version of a multi-armed bandit problem.

In probability theory and machine learning, the multi-armed bandit problem (sometimes called the K- or N-armed bandit problem) is a problem in which a fixed limited set of resources must be allocated between competing (alternative) choices in a way that maximizes their expected gain when each choice's properties are only partially known at the time of allocation and may become better understood as time passes or by allocating resources to the choice. The name comes from imagining a gambler at a row of slot machines (sometimes known as “one-armed bandits”). The gambler tries to maximize their reward, by deciding which machines to play, how many times or how long to play each machine, in which order to play them, and whether to continue with the current machine or try a different machine. Often, the gambler begins with no initial knowledge of the machines.

The multi-armed bandit problem exemplifies an exploration-exploitation tradeoff dilemma. When changing the settings of a processor running a workload, one must choose between “exploitation” of the setting with the highest expected payoff and “exploration” to get more information about the expected payoffs of other processor settings. In other words, each exploration of processor settings for running a workload means that the optimal setting may not be running. In the case of determining CPU settings to increase performance, each possible action is presented as one of the bandit's arms. The agent is trying to assess which action is most likely to succeed in a specific phase. Hence, there is a desire for an agent that quickly finds and implements the optimal settings for each workload.

An algorithm may implement the method 100. The algorithm enables the agent to optimize workloads performance by automatically amending hardware knobs, for example, through manipulating MSRs during workload runs. MSRs are low-level control registers exposed by the processor. These MSRs are accessed to adjust hardware knobs, such as enabling or disabling prefetching, dynamic frequency scaling, or turbo mode, based on the detected workload phase. The algorithm may be a Thompson-Sampling Gaussian Bandit and may be used as a solution for the multi-armed bandit problem using the Thompson Sampling technique. The agent uses the MSRs as a black box, treating them functionally, where the specific effects of each knob may be evaluated based on telemetry data rather than the internal operation of the register itself. Telemetry counters, such as branch instructions, CPU cycles, or branch misses, may be leveraged as inputs to evaluate the performance impact of the MSR settings during runtime. Adjustments to MSR values occur dynamically and autonomously during workload execution, ensuring minimal user involvement and maximizing efficiency.

The telemetry data is collected through hardware performance counters available on the processor. These counters are sampled during workload execution to detect steady or unsteady phases, which serve as the basis for determining the optimal MSR configurations. For example, the agent may determine that during the steady phase it is beneficial to enable certain prefetchers or dynamic frequency scaling. In contrast, unsteady phases revert settings to their defaults for stability. Treating the MSRs as a black box may mean that the Thompson-Sampling Gaussian Bandit does not require any pretraining. Therefore, it can be easily deployed to the firmware.

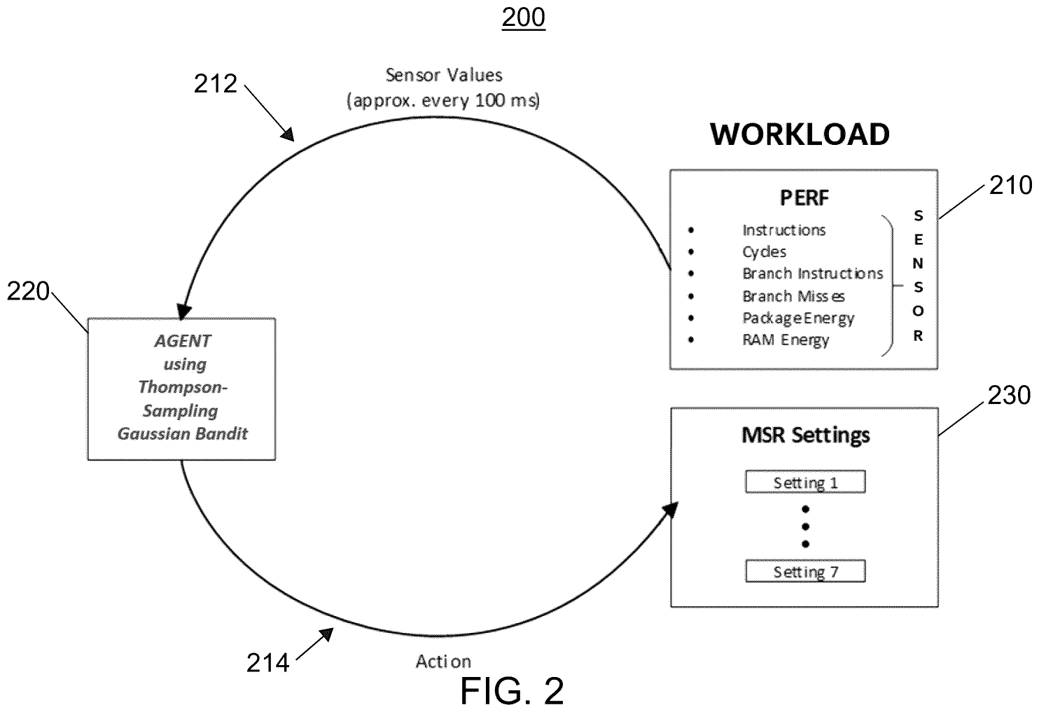

More details and aspects of the concept for adapting a processor to a workload may be described in connection with examples discussed below (e.g. FIGS. 2 to 8).

FIG. 2 shows a general schema of the agent control loop with a Thompson-Sampling Gaussian Bandit. The figure illustrates a schema 200 of the agent working on a physical CPU. The Thompson-Sampling Gaussian Bandit algorithm for the agent may include two elements. One is a steady phase detector to detect whether the workload is in a steady phase or not. Two, a Gaussian bandit tuner so that once in a steady phase, the tuner selects actions to gather knowledge and maximize the cumulative performance target. A steady phase may be a workload phase in which the agent chooses a specific action to optimize workload performance in this phase. An action may be a set of HW knobs settings applied on the CPU by an intelligent agent to maximize the workload performance.

The schema 200 for dynamically adapting a processor to a workload uses an agent implementing a Thompson-Sampling Gaussian Bandit algorithm. The schema comprises three main components: a workload 210, an agent 220, and model-specific registers (MSRs) settings 230.

The workload 210 generates performance telemetry values, including but not limited to instructions, cycles, branch instructions, branch misses, package energy, and RAM energy. These telemetry values are monitored and collected by sensors 212 approximately every 100 milliseconds.

The agent 220 processes the sensor values and determines actions 214 to adapt the processor settings. The agent implements a Thompson-Sampling Gaussian Bandit algorithm to evaluate the performance of multiple hardware settings and select the optimal action based on probabilistic modeling of performance metrics. The agent receives sensor data from the workload 210 and outputs actions 214 corresponding to updated MSR settings 230 to modify processor behavior.

The MSR settings 230 represent hardware configurations of the processor. Each MSR setting (e.g. Setting 1 through Setting 7) corresponds to a specific adjustment of hardware knobs, such as enabling or disabling prefetchers or modifying dynamic frequency scaling. These settings are applied to the processor in response to the agent's actions, completing the control loop.

The system operates as a feedback loop, where the workload 210 continuously provides sensor data to the agent 220, which, in turn, adjusts the MSR settings 230 through actions to optimize processor performance. The cycle repeats at regular intervals, such as every 100 milliseconds, enabling real-time adaptation to changing workload conditions.

A firmware agent using Thompson-Sampling Gaussian Bandit may provide customers with “free” performance and/or power/performance boost for workloads running on an old generation of CPUs (such as by a firmware update) or future CPU products. What differentiates this algorithm is that it is lightweight (for example, it does not consume enormous amounts of resources), does not require pretraining (therefore, is easily deployable), and works out of the box for a specific set of actions. Consequently, it may require little attention from a customer's and/or support team's perspective.

When an agent is implemented as firmware, it may be integrated into the processor's existing control systems, such as the power control unit (PCU). The lightweight design of the agent ensures that it does not require extensive computational resources and can operate alongside other firmware functionalities without interfering with normal processor operation. This design may allow for seamless updates to older processor generations via firmware patches, enabling performance enhancements for legacy CPUs. The agent may continuously monitor workload telemetry and adjust MSR values in real time, ensuring that the processor adapts to changes in workload behavior without requiring system restarts or additional input from users.

Some customers, such as data center (DC), high-performance computing (HPC), or cloud computing customers, may keep the older generation of CPUs as a base for their infrastructure. This may be due to a customer's limited ability to disrupt their DC availability and/or limited financial resources and/or unprofitability of the cost of HW exchange vs performance improvement obtained with new HW. In terms of deploying an agent for older generations of CPUs, the method may allow for a “free” performance boost for users and/or customers of older CPU generations.

Optionally, as shown in FIG. 1, the method 100 may further include receiving 105 a set of telemetry values from the processor. The set of telemetry values may include at least one of a plurality of instructions executed for the workload, a plurality of branch instructions executed for the workload, a plurality of cycles executed for the workload, a time measurement, a plurality of branch misses for the workload, an energy consumption of the processor, and an energy consumption of memory. In one embodiment, the set of telemetry values comprises a plurality of instructions executed for the workload, a plurality of branch instructions executed for the workload, and either a plurality of cycles executed for the workload or a time measurement.

The Thompson-Sampling Gaussian Bandit, as an algorithm, may be implemented for the intelligent agent operating in HW firmware. The capability of an intelligent agent or autotuner may be valuable across any server and/or client architecture. This agent may take as an input set of telemetry values—for example, a number of branch instructions, instructions, cycles, and branch misses. This set may be called a sensor. An example of a sensor could be [x, y, z], where x means number of CPU instructions executed for the workload between timestamp t and t−1, y means number of CPU cycles executed for the workload between timestamp t and t−1, and z means number of CPU branch instructions executed for the workload between timestamp t and t−1.

As an output, the method or algorithm produces an action recommendation. An action may be a set of HW knobs settings applied on the CPU by an intelligent agent to maximize the workload performance. An example of an action would be a recommendation presented as a bit mask. For example, a bit mask may be assumed to represent 7 different bits from 2 different MSRs. Table 1 shows an example of a bit mask representing action for a CPU.

TABLE 1

| | Bit number in bit mask action | | | | | | |
|---|---|---|---|---|---|---|---|
| | 6 | 5 | 4 | 3 | 2 | 1 | 0 |
| Default | 0 | 0 | 0 | 0 | 0 | 0 | 0 |
| bit value | | | | | | | |
| in bit | | | | | | | |
| mask | | | | | | | |
| MSR | 0x1a0; | 0x1a0; | 0x1a0; | 0x1a4; | 0x1a4; | 0x1a4; | 0x1a4; |
| and bit | bit 0 | bit 16 | bit 38 | bit 0 | bit 1 | bit 2 | bit 3 |
| number | | | | | | | |
| in MSR | | | | | | | |
| Default | 1 | 1 | 0 | 0 | 0 | 0 | 0 |
| value of | | | | | | | |
| MSR bit | | | | | | | |
| HW | Fast- | Dynamic | Turbo | L2 | L2 | DCU | DCU IP |
| feature | Strings | Frequency | Mode | Hardware | Adjacent | Hardware | Prefetcher |
| | Enable | Scaling | Disable | Prefetcher | Cache | Prefetcher | Disable |
| | | Enable | | Disable | Line | Disable | |
| | | | | | Prefetcher | | |
| | | | | | Disable | | |

By default, all bits in the bit mask have a value equal to 0. A bit mask containing only zeros represents the default settings for all MSR bits represented by the bit mask. An agent may then choose one of the 6 actions. Table 2 shows examples of mappings between action numbers, action bit masks, and which MSR bit is changed.

TABLE 2

| Action | Action bit | |
|---|---|---|
| number | mask | Which MSR bit is changed |
| 0 | 0000000 | None; these are default settings |
| | | for all MSR bits |
| 1 | 0000011 | 0x1a4; bit 2 AND 0x1a4; bit 3 |
| 2 | 0001010 | 0x1a4; bit 0 AND 0x1a4; bit 2 |
| 3 | 0001110 | 0x1a4; bit 0 AND 0x1a4; bit 1 AND |
| | | 0x1a4; bit 2 |
| 4 | 1100001 | 0x1a0; bit 0 AND 0x1a0; bit 16 AND |
| | | 0x1a4; bit 3 |
| 5 | 1100110 | 0x1a0; bit 0 AND 0x1a0; bit 16 AND |
| | | 0x1a4; bit 1 AND |
| | | 0x1a4; bit 2 |

With regards to the multi-armed bandit problem, each possible action is presented as one of the bandit's arms. The agent is trying to assess which action is most likely to succeed in a specific phase. The actions that an agent may determine may vary by processor. They may also be predetermined or discovered before runtime using artificial intelligence or machine learning.

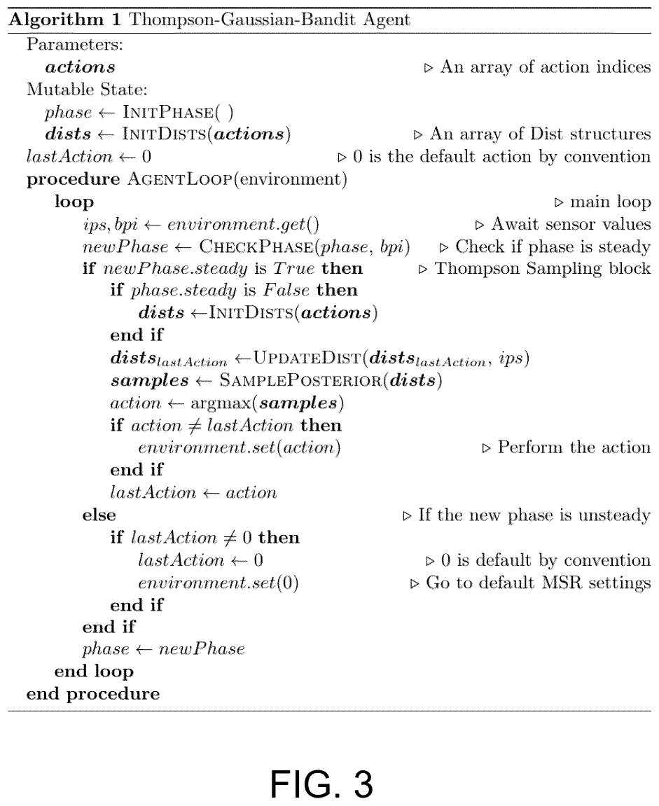

After being filled with input telemetry data, based on the output from the Thompson-Sampling Gaussian Bandit, the agent may recommend an action to be applied on the CPU, as shown in FIG. 2. FIG. 3 describes a holistic algorithm for this agent. It takes one parameter, a list of actions, where an action with index 0 is the default MSR setting by convention.

Optionally, as shown in FIG. 1, determining the performance of the processor 130 may include determining the number of IPS for each of the plurality of actions 132. The optimal action may be one of the plurality of actions where the number of IPS is maximized over the number of IPS of the default action. Detecting 110 when the workload transitions to the steady phase from the unsteady phase may include determining a running mean of branches per instruction (BPI) during a time window 112. The workload may be determined to be in a steady state when the number of BPIs remains within a threshold of the running mean of BPI.

Based on observation, workloads tend to spend extended time intervals in what may be called “steady phases,” that is, phases where performance metrics (such as IPS and BPI) remain on more-or-less constant levels, barring relatively small amounts of noise. Each time a workload reaches a steady phase, it can be expected that either a single best MSR setting will improve IPS over the default MSR setting, or the default setting is the best one. The algorithm aims to determine the current workload phase and, if steady, choose the best MSR setting as soon as possible. Once the workload leaves its steady phase, the agent reverts MSR settings to default and awaits another steady phase.

The agent may include safeguards to ensure that errors in telemetry data or unexpected workload behavior do not result in instability. If telemetry data indicates an unsteady phase or if collected data cannot be processed reliably, the agent may revert all MSR settings to their default values to maintain performance and stability. This ensures that the processor operates within expected parameters even in the event of transient errors. Access to MSRs by the agent may be controlled through privileged processor instructions, ensuring that only authorized processes or firmware can adjust these critical registers.

More details and aspects of the concept for adapting a processor to a workload may be described in connection with examples discussed above (e.g. FIG. 1) or below (e.g. FIGS. 3 to 8).

FIG. 3 shows an example of a Thompson-Sampling Gaussian Bandit algorithm description. The algorithm takes one parameter, a list of actions, where an action with index 0 is the default MSR setting by convention. The Thompson-Sampling Gaussian Bandit consists of two elements: a steady phase detector to detect whether the workload is in a steady phase or not and a Gaussian bandit tuner to select actions, once in a steady phase, to gather knowledge and maximize cumulative performance target.

The AgentLoop continuously monitors workload conditions and adapting processor settings. When the steady phase detector identifies a steady phase, the algorithm initializes distributions for each action using prior parameters. It then iteratively evaluates actions by updating the distributions with observed IPS values using the UpdateDist function and generates samples from the current distributions with SamplePosterior to select the next action. If the workload transitions out of the steady phase, the algorithm resets to the default action.

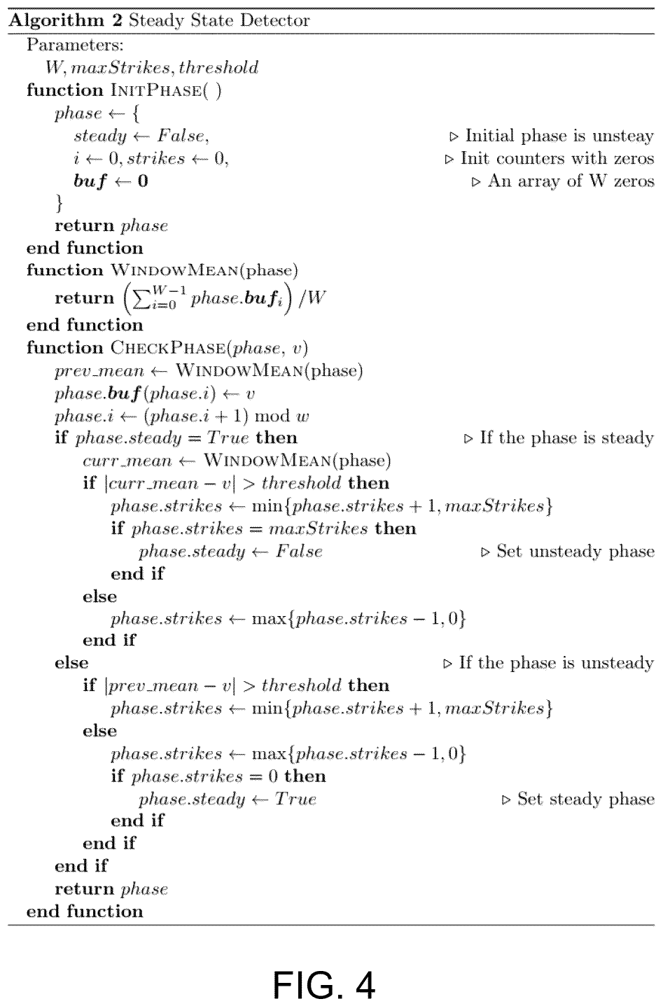

More details and aspects of the concept for adapting a processor to a workload may be described in connection with examples discussed above (e.g. FIG. 1 to 2) or below (e.g. FIGS. 4 to 8).

FIG. 4 shows an example of an algorithm for a steady-phase detector. The steady phase algorithm relies on the fact that performance counters tend to show steady behavior in extended time intervals. Whereas IPS tends to change in response to MSR manipulation, BPI does not. The latter may determine the steadiness of the workload phase, as the tuning stage would interfere with the former. An algorithm for determining the phases is described in detail in FIG. 4. It can be assumed that the workload is in a steady phase if the difference between a windowed running mean of the BPI signal and a subsequent BPI signal value stays below a threshold. The workload has left the steady phase if the difference exceeds the threshold for a certain time.

The steady phase algorithm takes three parameters, which should be tuned before deployment. The W parameter determines the width of the running mean window. The threshold parameter is the absolute value by which BPI can differ from the BPI windowed running mean. The maxStrikes parameter determines the maximum number of BPI values that go beyond the threshold but are ignored as outliers.

The CheckPhase function evaluates whether the workload remains in a steady phase by comparing the current BPI value to the running mean of the previous BPI values. It updates a phase buffer with a new BPI value, adjusts a strike counter based on deviations from the threshold, and determines whether the phase transitions to or from a steady state. A steady phase may be entered when the strike counter reaches zero, while an unsteady phase may be entered if the strike counter exceeds maxStrikes.

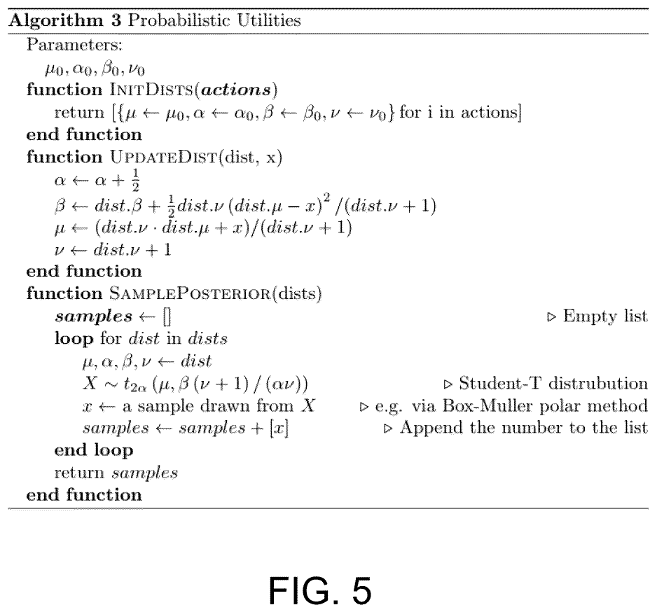

When reaching a steady phase, the agent tries different action values and models the results via one Gaussian distribution with an unknown mean or variance per MSR setting. The reward for taking an action is derived from the momentary IPS, which is also used to update the modeling distribution, yielding a Student-t posterior predictive for each MSR setting. The exploration/exploitation tradeoff is handled via Thompson Sampling as shown in FIG. 5.

As shown in FIG. 1, the method 100 may return to the 150 to the default action when the workload transitions to the unsteady state. This may be determined when the workload's BPI number exceeds the threshold of the running mean of BPI for a max number. An unsteady state may also be determined when the number of BPIs in the workload exceeds the threshold of the running mean of BPI for a time period.

More details and aspects of the concept for adapting a processor to a workload may be described in connection with examples discussed above (e.g. FIG. 1 to 3) or below (e.g. FIGS. 5 to 8).

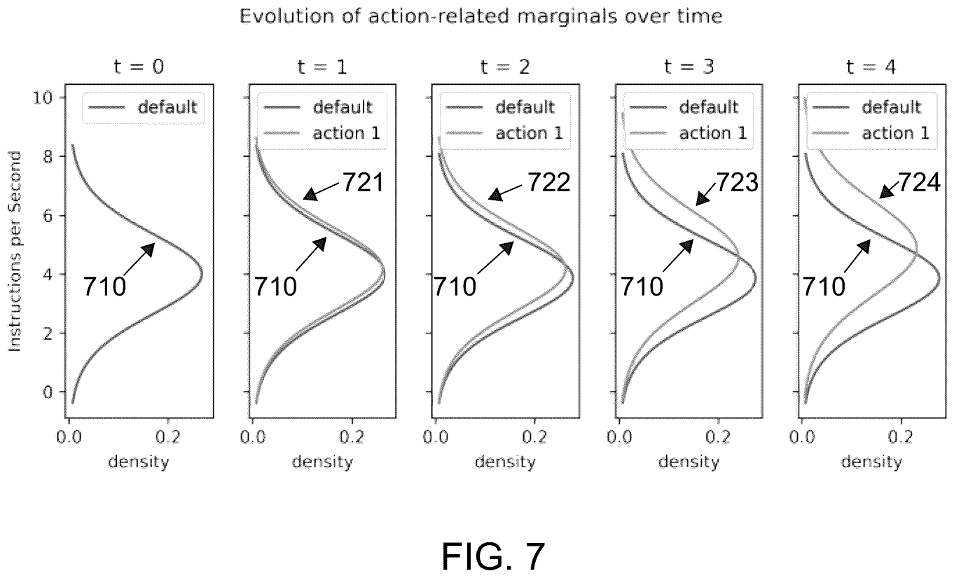

FIG. 5 shows an example of an algorithm for a Gaussian bandit tuner. When the steady phase ends, the agent returns to default settings and resets the distribution parameters. The probabilistic utilities used in the algorithm from FIG. 3 are shown in more detail in FIG. 5. A step-by-step example of the probabilistic update for two actions is shown in FIG. 7.

This InitDists function initializes a set of probability distributions for each action using prior parameters (μ₀, α₀, β₀, ν₀) that represent the mean, shape, rate, and degrees of freedom, respectively. As actions are sampled and evaluated, the UpdateDist function refines these distributions using observed IPS values. The SamplePosterior function then draws samples from the updated Student-t distributions for each action, enabling the agent to assess the potential of different actions while balancing exploration and exploitation.

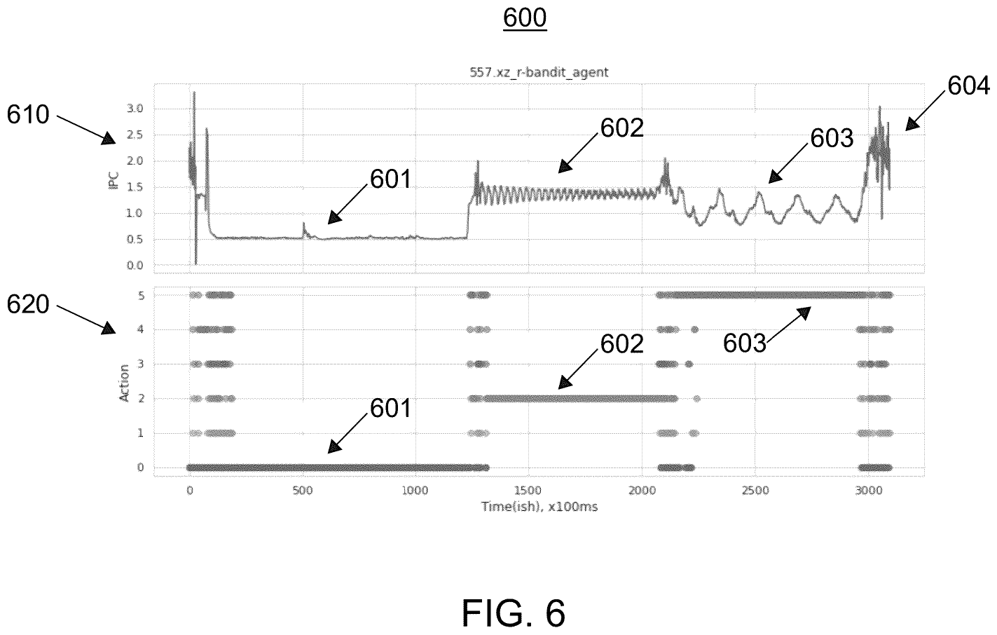

More details and aspects of the concept for adapting a processor to a workload may be described in connection with examples discussed above (e.g. FIG. 1 to 4) or below (e.g. FIGS. 6 to 8).

FIG. 6 shows an illustration 600 of Thompson-Sampling Gaussian Bandit working over time on the example of one of Standard Performance Evaluation Corporation's (SPEC®) SPECrate® 2017 Integer benchmarks-557.xz_r. This depiction shows three distinct steady states and the algorithm's actions during each state. The default action 0 was used with the first steady state, the second action 2 was used with the second steady state, and the fifth action 5 was used with the third steady state. The figure shows the algorithm dynamically adapting processor actions to optimize workload performance based on detected steady states.

The performance graph 610 on the top depicts IPC over time as a performance metric. IPC (shown on the vertical axis) provides an indication of processor efficiency, with variations illustrating transitions between steady and unsteady phases. The action graph 620 on the bottom shows the actions (shown on the vertical axis) selected by the algorithm at different time intervals. Each action corresponds to a specific configuration of hardware settings, such as enabling or disabling prefetchers or adjusting frequency scaling. Time intervals are indicated along the horizontal axis of each graph, with performance metrics and selected actions plotted over intervals of approximately 100 milliseconds.

The depiction highlights three distinct steady states: the first 601 lasting from approximately time 0 to time 1250, the second steady state 602 lasting from approximately time 1250 to 2250, and the third steady state 603 lasting from approximately time 2100 to 3100. An unsteady state 604 then lasts from lasting from approximately time 3100 onward.

In the first steady state 601, the algorithm applied the default action (action 0), maintaining baseline performance. In the second steady state 602, the algorithm selected action 2, reflecting a configuration optimized for that phase of the workload. In the third steady state 603, the algorithm transitioned to action 5.

Each steady state is characterized by an individual IPC pattern, which may differ significantly from one another. These patterns, however, demonstrate consistency and repeatability within their respective steady states, indicating the presence of a steady workload phase. Although a steady state may not show complete consistency, as shown in the first steady state 601, the consistency is greater than that of an unsteady state 604, which shows no pattern.

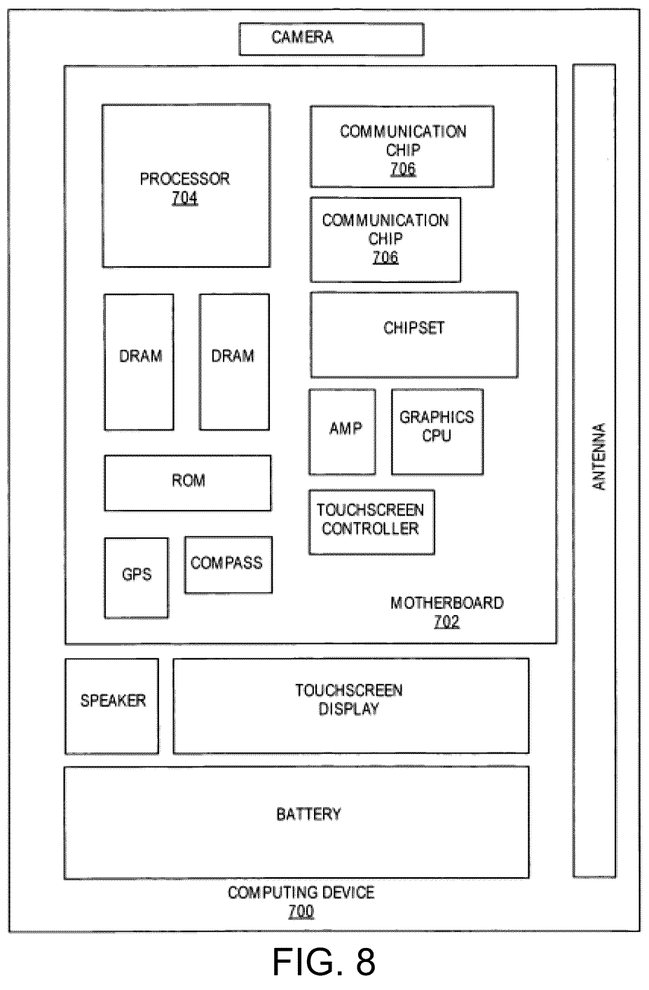

More details and aspects of the concept for adapting a processor to a workload may be described in connection with examples discussed above (e.g. FIG. 1 to 5) or below (e.g. FIG. 8).

FIG. 7 shows an illustration 700 of the probability distribution update of a particular action over time. The plurality of actions represent a unique set of a plurality hardware settings of the processor. These hardware settings may be exposed through MSRs. A processor may have from fewer than ten performance registers to over two thousand depending on its design. However, only a subset may be relevant for determining performance and appropriately tuning the processor.

Specifically, FIG. 7 depicts the evolution of action-related probability distributions at discrete time intervals (t=0 to t=4). The graph at each time step shows the probability density functions for the default action and an alternative action, referred to as action 1. The vertical axis represents the number of IPS, and the horizontal axis denotes probability density.

When a steady phase is detected, the agent may evaluate different action values and models their results using Gaussian distributions, with each distribution representing the IPS performance of a specific MSR setting. These Gaussian distributions are initialized with unknown mean and variance and are updated based on the observed IPS rewards for the selected actions. FIG. 7 illustrates this modeling process for two actions (default and action 1), showing how the probability distributions for action 1 evolve over successive time steps.

At time step t=0, only the default action has a distribution 710, as no alternative actions have yet been evaluated. As time progresses (t=1 to t=4), the algorithm samples actions, evaluates their performance, and refines the probability distributions for each action. At t=1, action 1 is initialized and its probability distribution 721 shows minimal differentiation from the default action's distribution 720. By t=2, action 1's probability distribution 722 begins to shift and center around a higher IPS value, reflecting improved performance. At t=3, the action 1's distribution 723 shows a further increase in peak density. Finally, at t=4, action 1's probability distribution 724 shows the greatest deviation from the default action's distribution 710, with a higher peak at a significantly greater IPS value.

The shifting of the distributions over time reflect the algorithm's learning process, where actions with higher expected performance (e.g. action 1 at later time steps) are increasingly favored. This update process demonstrates the algorithm's ability to refine an action's probability distribution over time, progressively optimizing processor settings for the workload. By the final time step (t=4), action 1's distribution 724 indicates a higher likelihood of achieving better performance compared to the default action 710. This demonstrates the effectiveness of the Thompson-Sampling Gaussian Bandit algorithm in progressively refining selections to optimize workload performance.

More details and aspects of the concept for adapting a processor to a workload may be described in connection with examples discussed above (e.g. FIG. 1 to 6) or below (e.g. FIG. 8).

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

A non-transitory, computer-readable medium comprising a program code may, when the program code is executed on a processor, a computer, or a programmable hardware component, cause the processor, computer, or programmable hardware component to perform the method for adapting a processor to a workload, wherein the workload may include a steady phase and an unsteady phase. The method may include detecting when the workload transitions to the steady phase from the unsteady phase, progressing through a plurality of actions of the processor from a default action of the plurality of actions, determining a performance of the processor for each of the plurality of actions, selecting an optimized action of the plurality of actions based on the corresponding performance of the processor and returning to the default action when the workload transitions to the unsteady phase from the steady phase.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g. via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, C, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

A software prototype of the agent showed performance gains for selected benchmarks from ˜1-2% to even 80% (depending on the workload and CPU generation). Table 3 shows examples of biggest performance gains as a result of workloads running along with the prototype of the agent. The workloads include SPEC CPU 2017 benchmark package and the Department of Energy (DOE)'s Quicksilver application.

TABLE 3

| | Launch | Performance |
|---|---|---|
| Workload | Year | Gain |
| DOE Quicksilver | 2019 | ~6% |
| DOE Quicksilver | 2018 | Up to 80% |
| SPEC CPU 2017 roms | 2023 | ~15% |
| SPEC CPU 2017 roms | 2019 | Up to 13% |
| SPEC CPU 2017 roms | 2018 | ~5% |
| SPEC CPU 2017 omnetpp | 2023 | Up to 11% |
| SPEC CPU 2017 omnetpp | 2019 | ~5% |

Tables 3 to 6 show performance results from agent software prototype tests. There are several proofs of significant performance gains for the particular workloads.

Table 4 shows the results of experiments on a server with a processor architecture from 2023, showing potential performance gains due to Thompson-Sampling Gaussian Bandit running with specific workloads.

TABLE 4

| | fom % diff to | | fom % diff to |
|---|---|---|---|
| workload | default | workload | default |
| spec_cpu-554.roms_r- | 14.758282 | spec_cpu- | 7.051098 |
| result | | 520.omnetpp_r-result | |
| cnn-default-Train time as | 2.456513 | cnn-default-Train | 3.124534 |
| rate | | throughput | |
| cnn-default-Train | 2.456513 | cnn-default-Train time as | 3.124534 |
| throughput | | rate | |
| cnn-default-Total time as | 1.685643 | cnn-default-Total time as | 1.779364 |
| rate | | rate | |
| spec_cpu-510.parest_r- | 0.935109 | spec_cpu- | 0.879675 |
| result | | 523.xalancbmk_r-result | |
| spec_cpu- | 0.918880 | spec_cpu- | 0.065229 |
| 549.fotonik3d_r-result | | 500.perlbench_r-result | |
| spec_cpu-519.lbm_r- | 0.412477 | spec_cpu-541.leela_r- | −0.063009 |
| result | | result | |
| spec_cpu-511.povray_r- | −0.051498 | spec_cpu-557.xz_r-result | −0.093679 |
| result | | | |
| spec_cpu-521.wrf_r-result | −0.061044 | spec_cpu- | −0.172304 |
| | | 548.exchange2_r-result | |
| spec_cpu-508.namd_r- | −0.074444 | Spec_cpu-525.x364_r- | −0.181148 |
| result | | result | |
| spec_cpu-526.blender_r- | −0.108882 | quicksilver-default- | −0.251516 |
| result | | steps_per_s | |
| spec_cpu-503.bwaves_r- | −0.152799 | spec_cpu-505.mcf_r- | −1.507052 |
| result | | result | |
| quicksilver-default- | −0.290540 | spec_cpu-502.gcc_r- | −2.052584 |
| steps_per_s | | result | |
| spec_cpu-544.nab_r-result | −0.484158 | | |
| spec_cpu- | −0.638637 | | |
| 507.cactuBSSN_r-result | | | |
| spec_cpu-538.imagick_r- | −0.663777 | | |
| result | | | |
| spec_cpu-527.cam4_r- | −2.013786 | | |
| result | | | |

Table 5 shows the results of experiments on a server with a processor architecture from 2019, showing potential performance gains due to Thompson-Sampling Gaussian Bandit running with specific workloads.

TABLE 5

| | fom % diff to | | fom % diff to |
|---|---|---|---|
| workload | default | workload | default |
| spec_cpu-554.roms_r- | 4.59734 | spec_cpu-520.omnetpp_r- | 4.86929 |
| result | | result | |
| spec_cpu- | 0.72664 | quicksilver-default- | 2.54573 |
| 549.fotonik3d_r-result | | steps_per_s | |
| spec_cpu-503.bwaves_r- | 0.05533 | cnn-default-Total time as | 0.49404 |
| result | | rate | |
| quicksilver-default- | −0.00000 | spec_cpu- | 0.39762 |
| steps_per_s | | 500.perlbench_r-result | |
| spec_cpu-511.povray_r- | −0.03212 | cnn-default-Train | 0.25097 |
| result | | throughput | |
| spec_cpu-521.wrf_r-result | −0.12193 | cnn-default-Train time as | 0.25097 |
| | | rate | |
| spec_cpu-508.namd_r- | −0.75888 | spec_cpu-541.leela_r- | 0.21153 |
| result | | result | |
| cnn-default-Train time as | −0.77830 | spec_cpu-525.x264_r- | −0.10544 |
| rate | | result | |
| cnn-default-Train | −0.87351 | spec_cpu- | −0.18341 |
| throughput | | 531.deepsjeng_r-result | |
| spec_cpu-526.blender_r- | −0.92805 | spec_cpu-557.xz_r-result | −0.28817 |
| result | | | |
| spec_cpu-544.nab_r-result | −1.12177 | spec_cpu- | −1.57988 |
| | | 548.exchange2_r-result | |
| spec_cpu-510.parest_r- | −1.96049 | spec_cpu- | −2.19646 |
| result | | 523.xalancbmk_r-result | |
| spec_cpu-538.imagick_r- | −2.14415 | spec_cpu-505.mcf_r- | −4.41276 |
| result | | result | |
| spec_cpu-527.cam4_r- | −2.44945 | spec_cpu-502.gcc_r-result | −11.17123 |
| result | | | |
| spec_cpu- | −2.80655 | | |
| 507.cactuBSSN_r-result | | | |
| spec_cpu-519.lbm_r-result | −2.82878 | | |
| cnn-default-Total time as | −3.21561 | | |
| rate | | | |

Table 6 shows the results of experiments on a server with a processor architecture from 2018 (left) and a server with a processor architecture from 2015 (right), showing potential performance gains due to Thompson-Sampling Gaussian Bandit running with specific workloads.

TABLE 6

| | fom % diff to | | fom % diff to |
|---|---|---|---|
| workload | default | workload | default |
| quicksilver-default- | 40.81690 | quicksilver-default- | 46.43447 |
| steps_per_s | | steps_per_s | |
| spec_cpu-554.roms_r- | 3.38756 | cnn-default-Train time as | 1.58453 |
| result | | rate | |
| enn-default-Total time as | 0.23821 | cnn-default-Train | 1.58453 |
| rate | | throughput | |
| spec_cpu-519.lbm_r- | 0.09038 | spec_cpu- | 0.11432 |
| result | | 548.exchange2_r-result | |
| spcc_cpu-511.povray_r- | 0.03140 | spec_cpu-557.xz_r-result | 0.01700 |
| result | | | |
| spec_cpu- | −0.04994 | spec_cpu-541.leela_r- | −0.02931 |
| 500.perlbench_r-result | | result | |
| spec_cpu-503.bwaves_r- | −0.35087 | spec_cpu- | −0.06092 |
| result | | 531.deepsjeng_r-result | |
| spec_cpu-526.blender_r- | −0.36709 | spec_cpu-525.x264_r- | −0.06397 |
| result | | result | |
| spec_cpu- | −0.54564 | spec_cpu- | −0.15139 |
| 549.fotonik3d_r-result | | 500.perlbench_r-result | |
| spec_cpu-544.nab_r-result | −0.99491 | spec_cpu-511.povray_r- | −0.18637 |
| | | result | |
| spec_cpu-510.parest_r- | −1.03745 | spec_cpu-520.omnetpp_r- | −0.19437 |
| result | | result | |
| spec_cpu-508.namd_r- | −1.05237 | spec_cpu-519.lbm_r- | −0.32711 |
| result | | result | |
| spec_cpu- | −1.52284 | spec_cpu-554.roms_r- | −0.42546 |
| 507.cactuBSSN_r-result | | result | |
| cnn-default-Train | −1.52652 | cnn-default-Total time as | −0.73208 |
| throughput | | rate | |
| cnn-default-Train time as | −1.52652 | spec_cpu-503.bwaves_r- | −0.84985 |
| rate | | result | |
| spec_cpu-521.wrf_r-result | −1.88831 | spec_cpu-526.blender_r- | −0.95570 |
| | | result | |
| spec_cpu-505.mcf_r- | −3.52537 | spec_cpu- | −1.13007 |
| result | | 507.cactuBSSN_r-result | |
| spec_cpu-527.cam4_r- | −4.39039 | spec_cpu-508.namd_r- | −1.21003 |
| result | | result | |
| spec_cpu-538.imagick_r- | −4.85536 | spec_cpu-544.nab_r-result | −1.48048 |
| result | | | |
| spec_cpu-502.gcc_r-result | −10.91605 | spec_cpu- | −1.90392 |
| | | 523.xalancbmk_r-result | |
| | | spec_cpu-527.cam4_r- | −2.51221 |
| | | result | |
| | | spec_cpu- | −2.71650 |
| | | 549.fotonik3d_r-result | |
| | | spec_cpu-510.parest_r- | −3.18853 |
| | | result | |
| | | spec_cpu-538.imagick_r- | −3.21434 |
| | | result | |
| | | spec_cpu-505.mcf_r- | −5.33222 |
| | | result | |
| | | spec_cpu-502.gcc_r-result | −5.50687 |
| | | spec_cpu-521.wrf_r-result | −5.86155 |

The method or agent may be implemented in firmware or as an apparatus for adapting a processor to a workload, wherein the workload includes a steady phase and an unsteady phase. The apparatus may comprise processing circuitry to detect when the workload transitions to the steady phase from the unsteady phase, progress through a plurality of actions of the processor from a default action of the plurality of actions, determine a performance of the processor for each of the plurality of actions, select an optimized action of the plurality of actions based on the corresponding performance of the processor, and return to the default action when the workload transitions to the unsteady phase from the steady phase.

The processing circuitry may be further configured to receive a set of telemetry values from the processor. The set of telemetry values includes at least one of a plurality of instructions executed for the workload, a plurality of branch instructions executed for the workload, a plurality of cycles executed for the workload, a time measurement, a plurality of branch misses for the workload, an energy consumption of the processor, and an energy consumption of memory.

The processing circuitry may be further configured to determine a number of IPS for each of the plurality of actions, wherein the optimal action is one of the plurality of actions where the number of IPS is maximized over the number of IPS of the default action.

The processing circuitry may be further configured to determine a running mean of BPI during a time window, wherein the workload is in the steady state when a number of BPI of the workload remains within a threshold of the running mean of BPI.

The processing circuitry may be further configured to determine when the workload is in the unsteady state when the number of BPI of the workload exceeds the threshold of the running mean of BPI for a max number or for a time period.

Each of the plurality of actions may be a unique set of a plurality hardware settings of the processor and the plurality of hardware settings may be exposed through model-specific registers. How the registers are tuned depends on where the agent is located. A software agent, an agent implement in a kernel, and a firmware agent may tune different registers depending on how they are able to access MSRs.

During operation, the agent initializes by collecting telemetry data from performance counters exposed by the processor. It evaluates metrics such as branch-instructions, IPS, and CPU cycles over defined intervals. When a steady phase is detected, the agent adjusts MSR values to optimize performance, such as enabling certain prefetchers or adjusting dynamic frequency scaling parameters. If the telemetry indicates that the workload transitions to an unsteady phase, the agent reverts the MSR settings to their defaults. This dynamic adaptation process continues throughout the workload execution, ensuring consistent performance improvements while maintaining system stability.

Processing circuitry or means for processing may be implemented using one or more processing units, one or more processing devices, any means for processing, such as a processor, a computer or a programmable hardware component being operable with accordingly adapted software. In other words, the described function of the processing circuitry or means for processing may as well be implemented in software, which is then executed on one or more programmable hardware components. Such hardware components may comprise a general-purpose processor, a Digital Signal Processor (DSP), a micro-controller, etc.

For example, the storage circuitry or means for storing information may comprise at least one element of the group of a computer readable storage medium, such as a magnetic or optical storage medium (e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage).

FIG. 8 shows illustrates a computing device 700 in accordance with one implementation of the invention. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704.

Depending on its applications, computing device 700 may include other components that may or may not be physically and electrically coupled to the board 702. These other components include, but are not limited to, volatile memory (e.g. DRAM), non-volatile memory (such as, ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as, hard disk drive, compact disk (CD), digital versatile disk (DVD), and so forth).

The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others.

The processor 704 of the computing device 700 includes an integrated circuit die packaged within the processor 704. In some implementations of the invention, the integrated circuit die of the processor includes one or more devices that are assembled in an ePLB or eWLB based POP package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory.

The communication chip 706 also includes an integrated circuit die packaged within the communication chip 706. In accordance with another implementation of the invention, the integrated circuit die of the communication chip includes one or more devices that are assembled in an ePLB or eWLB based POP package that that includes a mold layer directly contacting a substrate, in accordance with implementations of the invention.

More details and aspects of the concept for adapting a processor to a workload may be described in connection with examples discussed above (e.g. FIG. 1 to 7) or below.

The aspects and features described in relation to a particular one of the previous examples may also be combined with one or more of the further examples to replace an identical or similar feature of that further example or to additionally introduce the features into the further example.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

An example (e.g. example 1) relates to a method for adapting a processor to a workload, wherein the workload comprises a steady phase and an unsteady phase. The method comprising detecting when the workload transitions to the steady phase from the unsteady phase; progressing through a plurality of actions of the processor from a default action of the plurality of actions; determining a performance of the processor for each of the plurality of actions; selecting an optimized action of the plurality of actions based on the corresponding performance of the processor; and returning to the default action when the workload transitions to the unsteady phase from the steady phase.

Another example (e.g. example 2) relates to a previously described example (e.g. example 1), further comprising receiving a set of telemetry values from the processor.

Another example (e.g. example 3) relates to a previously described example (e.g. example 2), wherein the set of telemetry values comprises at least one of: a plurality of instructions executed for the workload; a plurality of branch instructions executed for the workload; a plurality of cycles executed for the workload; a time measurement, a plurality of branch misses for the workload; an energy consumption of the processor; and an energy consumption of a memory.

Another example (e.g. example 4) relates to a previously described example (e.g. example 2), wherein the set of telemetry values comprises: a plurality of instructions executed for the workload; a plurality of branch instructions executed for the workload; and a plurality of cycles executed for the workload or a time measurement.

Another example (e.g. example 5) relates to a previously described example (e.g. example 3), wherein the set of telemetry values further comprises at least one of: a plurality of branch misses for the workload; an energy consumption of the processor; and an energy consumption of a memory.

Another example (e.g. example 6) relates to a previously described example (e.g. one of the examples 1-5), wherein determining the performance of the processor comprises a determining a number of instructions per second (IPS) for each of the plurality of actions, and wherein the optimal action is one of the plurality of actions where the number of IPS is maximized over the number of IPS of the default action.

Another example (e.g. example 7) relates to a previously described example (e.g. one of the examples 1-6), wherein detecting when the workload transitions to the steady phase from the unsteady phase comprises determining a running mean of branches per instruction (BPI) during a time window; and wherein the workload is in the steady state when a number of BPI of the workload remains within a threshold of the running mean of BPI.

Another example (e.g. example 8) relates to a previously described example (e.g. example 7), wherein the workload is in the unsteady state when the number of BPI of the workload exceeds the threshold of the running mean of BPI for a max number.

Another example (e.g. example 9) relates to a previously described example (e.g. example 7), wherein the workload is in the unsteady state when the number of BPI of the workload exceeds the threshold of the running mean of BPI for a time period.

Another example (e.g. example 10) relates to a previously described example (e.g. one of the examples 1-9), wherein each of the plurality of actions is a unique set of a plurality hardware settings of the processor.

Another example (e.g. example 11) relates to a previously described example (e.g. one of the examples 1-10), wherein the plurality of hardware settings are exposed through model-specific registers.

Another example (e.g. example 12) relates to a non-transitory, computer-readable medium including a program code that, when the program code is executed on a processor, a computer, or a programmable hardware component, causes the processor, the computer, or the programmable hardware component to perform a method of previously described example (e.g. one of the examples 1-11).

An example (e.g. example 13) relates to an apparatus for adapting a processor to a workload, wherein the workload comprises a steady phase and an unsteady phase. The apparatus comprising processing circuitry to detect when the workload transitions to the steady phase from the unsteady phase; progress through a plurality of actions of the processor from a default action of the plurality of actions; determine a performance of the processor for each of the plurality of actions; select an optimized action of the plurality of actions based on the corresponding performance of the processor; and return to the default action when the workload transitions to the unsteady phase from the steady phase.

Another example (e.g. example 14) relates to a previously described example (e.g. example 13), wherein the processing circuitry is further configured to receive a set of telemetry values from the processor.

Another example (e.g. example 15) relates to a previously described example (e.g. example 14), wherein the set of telemetry values comprises at least one of: a plurality of instructions executed for the workload; a plurality of branch instructions executed for the workload; a plurality of cycles executed for the workload; a time measurement, a plurality of branch misses for the workload; an energy consumption of the processor; and an energy consumption of a memory.

Another example (e.g. example 16) relates to a previously described example (e.g. example 14), wherein the set of telemetry values comprises: a plurality of instructions executed for the workload; a plurality of branch instructions executed for the workload; and a plurality of cycles executed for the workload or a time measurement.

Another example (e.g. example 17) relates to a previously described example (e.g. example 16) wherein the set of telemetry values further comprises at least one of: a plurality of branch misses for the workload; an energy consumption of the processor; and an energy consumption of a memory.

Another example (e.g. example 18) relates to a previously described example (e.g. one of the examples 13-17), wherein determining the performance of the processor comprises a determining a number of instructions per second (IPS) for each of the plurality of actions, and wherein the optimal action is one of the plurality of actions where the number of IPS is maximized over the number of IPS of the default action.

Another example (e.g. example 19) relates to a previously described example (e.g. one of the examples 13-18), wherein detecting when the workload transitions to the steady phase from the unsteady phase comprises determining a running mean of branches per instruction (BPI) during a time window; and wherein the workload is in the steady state when a number of BPI of the workload remains within a threshold of the running mean of BPI.

Another example (e.g. example 20) relates to a previously described example (e.g. example 19), wherein the workload is in the unsteady state when the number of BPI of the workload exceeds the threshold of the running mean of BPI for a max number.

Another example (e.g. example 21) relates to a previously described example (e.g. example 19), wherein the workload is in the unsteady state when the number of BPI of the workload exceeds the threshold of the running mean of BPI for a time period.

Another example (e.g. example 22) relates to a previously described example (e.g. one of the examples 13-21), wherein each of the plurality of actions is a unique set of a plurality hardware settings of the processor.

Another example (e.g. example 23) relates to a previously described example (e.g. one of the examples 13-22), wherein the plurality of hardware settings are exposed through model-specific registers.

The aspects and features described in relation to a particular one of the previous examples may also be combined with one or more of the further examples to replace an identical or similar feature of that further example or to additionally introduce the features into the further example.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory, computer-readable medium comprising a program code for adapting a processor to a workload that, when executed on the processor, a computer, or a programmable hardware component, causes the processor, the computer, or the programmable hardware component to:
detect when the workload transitions to a steady phase from an unsteady phase;
progress through a plurality of actions of the processor from a default action of the plurality of actions;
determine a performance of the processor for each of the plurality of actions;
select an optimized action of the plurality of actions based on the corresponding performance of the processor; and
return to the default action when the workload transitions to the unsteady phase from the steady phase.

2. The computer-readable medium of claim 1, further comprising the machine-readable instructions to receive a set of telemetry values from the processor.

3. The computer-readable medium of claim 2, wherein the set of telemetry values comprises:
a plurality of instructions executed for the workload;
a plurality of branch instructions executed for the workload; and
a plurality of cycles executed for the workload.

4. The computer-readable medium of claim 3, wherein the set of telemetry values further comprises at least one of:
a plurality of branch misses for the workload;
an energy consumption of the processor; and
an energy consumption of a memory.

5. The computer-readable medium of claim 1,
wherein determining the performance of the processor comprises a determining a number of instructions per second (IPS) for each of the plurality of actions, and
wherein the optimal action is one of the plurality of actions where the number of IPS is maximized over the number of IPS of the default action.

6. The computer-readable medium of claim 1,
wherein detecting when the workload transitions to the steady phase from the unsteady phase comprises determining a running mean of branches per instruction (BPI) during a time window; and
wherein the workload is in the steady state when a number of BPI of the workload remains within a threshold of the running mean of BPI.

7. The computer-readable medium of claim 6,
wherein the workload is in the unsteady state when the number of BPI of the workload exceeds the threshold of the running mean of BPI for a max number.

8. The computer-readable medium of claim 6,
wherein the workload is in the unsteady state when the number of BPI of the workload exceeds the threshold of the running mean of BPI for a time period.

9. The computer-readable medium of claim 1, wherein each of the plurality of actions is a unique set of a plurality hardware settings of the processor.

10. The computer-readable medium of claim 9, wherein the plurality of hardware settings are exposed through model-specific registers.

11. An apparatus for adapting a processor to a workload, the apparatus comprising processing circuitry to:
detect when the workload transitions to a steady phase from an unsteady phase;
progress through a plurality of actions of the processor from a default action of the plurality of actions;
determine a performance of the processor for each of the plurality of actions;
select an optimized action of the plurality of actions based on the corresponding performance of the processor; and
return to the default action when the workload transitions to the unsteady phase from the steady phase.

12. The apparatus of claim 11, wherein the processing circuitry is further configured to receive a set of telemetry values from the processor.

13. The apparatus of claim 12, wherein the set of telemetry values comprises:
a plurality of instructions executed for the workload;
a plurality of branch instructions executed for the workload; and
a plurality of cycles executed for the workload.

14. The apparatus of claim 13, wherein the set of telemetry values further comprises at least one of:
a plurality of branch misses for the workload;
an energy consumption of the processor; and
an energy consumption of a memory.

15. The apparatus of claim 11,
wherein determining the performance of the processor comprises a determining a number of instructions per second (IPS) for each of the plurality of actions, and
wherein the optimal action is one of the plurality of actions where the number of IPS is maximized over the number of IPS of the default action.

16. The apparatus of claim 11,
wherein detecting when the workload transitions to the steady phase from the unsteady phase comprises determining a running mean of branches per instruction (BPI) during a time window; and
wherein the workload is in the steady state when a number of BPI of the workload remains within a threshold of the running mean of BPI.

17. The apparatus of claim 16,
wherein the workload is in the unsteady state when the number of BPI of the workload exceeds the threshold of the running mean of BPI for a max number.

18. The apparatus of claim 16,
wherein the workload is in the unsteady state when the number of BPI of the workload exceeds the threshold of the running mean of BPI for a time period.

19. The apparatus of claim 1, wherein each of the plurality of actions is a unique set of a plurality hardware settings of the processor.

20. The apparatus of claim 19, wherein the plurality of hardware settings are exposed through model-specific registers.
